(19) United States
(12) Patent Application Publication
(10) Pub. No.: US 2009/0029262 A1
(43) Pub. Date: Jan. 29, 2009

(54) Separator and electrical/electronic components using the same

(76) Inventor: Shinji Naruse, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/659,426

(22) PCT Filed: Aug. 11, 2005
(86) PCT No.: PCT/JP2005/015035

§ 371 Date: Feb. 5, 2007

(30) Foreign Application Priority Data
Aug. 12, 2004 (JP) 2004-235550

(51) Int. Cl. H01M 2/16

(52) U.S. Cl. 429/254

(57) ABSTRACT

The invention provides a separator characterized by a constitution wherein a porous sheet formed of a thermoplastic polymer having a melting point of 200° C. or lower is incorporating a thin sheet material comprising an organic compound substantially having no stable melting point, which is useful for secondary batteries or capacitors having both the shutting-down function and the high temperature shape stability.

### TECHNICAL FIELD

The present invention relates to a separator capable of passing electrolyte or ions in electrolytic solution and useful, for example, for separation between positive and negative electrode members in secondary batteries, and electrical/electronic components utilizing the same, such as batteries, capacitors and the like. In particular, the invention relates to a separator constituted of a sheet comprising plural organic compounds having different thermal properties, which is useful as a separator in secondary batteries which use ions of an alkali metal, such as lithium, sodium, etc. as the current carrier.

### BACKGROUND ART

Secondary batteries and capacitors are currently being used as electric power sources for portable electronic devices, etc., and are partially commercially used as electric power sources for electric cars and hybrid cars, while the installation of various batteries on these electronic devices and electric and hybrid cars are under investigation. Particularly, high performance secondary batteries and capacitors in reduced sizes and weights, having high energy densities and capable of withstanding storage over a prolonged period of time are expectedly very promising and efforts for their broad applications are being undertaken.

Generally, the typical lithium secondary battery is mainly constituted of power generation elements comprising a positive electrode utilizing a complex oxide with transient metal containing Li ions as the positive electrode active substance, a negative electrode using a carbon-based material capable of adsorbing and releasing Li ions as the negative electrode active substance, a separator to be inserted between the positive and negative electrodes, and an electrolyte solution comprising an electrolyte such as LiPF6 or LiBF4 or the like, and an organic solvent. Furthermore, the power generation elements are contained in a battery container, and hermetically sealed with positive and negative electrode terminals respectively connected to the positive and negative electrodes and a gasket. For the positive and negative electrodes, power collectors in a band shape respectively using a predetermined metal are formed by forced molding.

In this occasion, general properties required for the separator include the following, among others:
(1) To have, in addition to the function of separating electrode materials, the function of breaking the battery circuit (shutting down property) when an excessive electric current is flown due to shortage in various sections, etc.;
(2) To provide the good passage of electrolytes and ions when an electrolytic solution is retained;
(3) To provide electric insulation;
(4) To be chemically stable to an electrolytic solution and simultaneously electrochemically stable, too; and
(5) To have mechanical strength, to be formable in a thinner membrane, and to be easily wetted by an electrolytic solution to provide the good retention of the electrolytic solution.
   Particularly, the shutting down property is extremely important in the sense of preventing the rapid progress of chemical reaction due to the excessive current flow in the battery or the violent driving of the battery circuit.

So far, porous sheets formed from polyolefin polymer such as polyethylene (PE) or polypropylene (PP) have been broadly used as the separators. The porous sheet is produced by 1) a process wherein a plasticizing solvent and polymer are kneaded for forming film and subsequently the solvent is extracted for cleaning (which is generally called a wet process), or 2) a process wherein sheet is formed by extruding molten polymer and is subsequently drawn to orientation to cause cracking so as to form micro pores (which is generally called a dry process). The separator thus produced is used in a battery cell as a single layer or plural layers in lamination, or as being wound to form a roll.

The selection and adoption of polyethylene (PE) having the melting point of 130° C. or polypropylene (PP) having the melting point of 170° C. as the separator material can cause the heat shrinkage/melting of these separator materials due to an increased temperature brought by heat generated when an excessive current flows within the battery because of the above explained external shortage or some external factors, which is accompanied by the blockage of the micro multiple pores so as to work for breaking the battery circuit. From the viewpoint that the micro multiple pores can be more safely blocked at a lower temperature, polyethylene (PE) is mainly selected as the separator material.

For the protection of a battery circuit, PTC and other safety device functions may be assembled in the external circuit, beside the separator. Yet, for the secondary battery to be used in the electric car and hybrid car applications, which are expected to greatly grow in future, since there are possibilities that external safety device circuits are broken due to impacts during collision accidents, etc., it is believably essential in consideration of such possibilities to adopt a separator provided with the shutting down property from the view point of the fool-proof safety.

Furthermore, along with this shutting down property, the shape retention capability of a separator when the temperature continues to rise after shutting down is also an important element. Namely, a problem has been pointed out that, when polymer having a melting point within the range of 120-170 such as polyethylene (PE) or polypropylene (PP) is adopted as the separator, the separator itself can be molten as the temperature continues increasing even after the shutting down due to some reason, resulting in the substantially complete loss of the current-breaking function. When the separator loses its shape too quickly, a dangerous situation can occur where the shortage of electrodes is caused.

In order to solve such a problem, several proposals have been made to use a multiple component material for the separator in secondary batteries, wherein a high melting material is combined with a low melting material, the low melting material to provide the shutting down function and the high melting material to provide the shape retention function at a high temperature. For example, composite fiber non-woven cloth having a core-sheath structure is described in Laid-Open Japanese Patent Application Sho-61-232560 A, and micro porous membrane formed from plural kinds of materials having different melting points is disclosed in Laid-Open Japanese Patent Application Sho-63-308866 A. On the other hand, a structural member formed by the lamination of a micro porous membrane comprising a low melting resin and non-woven fabric comprising a higher melting polymer is proposed in Laid-Open Japanese Patent Application Hei-01-258358 A.

Yet, the melting point of a higher melting material disclosed in these patent literatures is at the maximum 270° C., and the glass transition temperature (Tg) as a measure for indicating the start of thermal movements of the polymer is 100° C. or less. Thus, the separator shape and the function of preventing shortage cannot be expected to be completely retainable when a temperature increase is suddenly and locally caused. Particularly when the polymer used is such as constituting a regular separator, the possibility of a local temperature increase and the resulting melting cannot be denied of their occurrence because the thermal conductivity of such the polymer is generally low.

The separator comprising the lamination of polyethylene (PE) porous film and polypropylene (PP) porous film has been commercially utilized, but this constitution has not essentially solved the problem of thermal instability. In addition, with the advancing size reduction of batteries in the latest years, the separator has been demanded to be made as an increasingly thinner sheet material. Therefore, the multiple layered structure cannot be necessarily considered to be always compatible with this demand.

Furthermore, proposals have been made to use thermally stable aramid (aromatic polyamide) as a separator component (refer to Laid-Open Japanese Patent Applications Hei-05-033005 A, Hei-07-037571 A and Hei-07-078608 A). These proposals teach to use the excellently heat resistant aramid fiber/pulp combination, but do not disclose the provision of the shutting down function.

Non-woven cloth for the battery separator use, which contains at least fibrillated organic fiber, is disclosed in Laid-Open Japanese Patent Application Hei-09-027311 A. The non-woven fabric may contain, as taught therein, low melting fiber such as polyethylene fiber, polypropylene fiber, etc., but when the low melting component is in the form of fiber, an area to be covered by its possible melting cannot be substantially large, and therefore, the above described shutting down function cannot be expected to be sufficiently exhibited.

Thus, currently, there is no available sheet material at all for the separator to be used in batteries and capacitors, particularly secondary batteries, which has a safety device function provided with both the shutting down function and the shape retention at a high temperature. In order to develop the future industrial application of lithium secondary batteries, the development of a battery separator having such the safety device function has been desired.

### DISCLOSURE OF INVENTION

A purpose of the present invention is to provide a separator having both the excellent shutting down function and the shape stability at a high temperature, which are important properties for the safety of secondary batteries.

A further purpose of the present invention is to provide electrical/electronic components such as batteries, capacitors, etc. which have improved stability due to the provision of such a separator.

In consideration of such situations, the present inventors have been repeatedly engaged in concentrated studies to develop a separator material which is provided with both the reliable shutting down function and the shape stability at a high temperature, and have now found that these purposes can be achieved by causing a micro-porous sheet comprising a thermoplastic polymer having a melting point of 200° C. or lower to incorporate a thin sheet material comprising an organic compound substantially having no stable melting point, thus eventually having completed the present invention.

Thus, a separator is provided according to the present invention, which is characterized by a constitution wherein a porous sheet formed of a thermoplastic polymer having a melting point of 200° C. or lower is incorporating a thin sheet material comprising an organic compound substantially having no stable melting point.

In the following, the present invention shall be further explained in detail.

### Melting Point

The melting point of polymer according to the present invention is to be measured according to a thermal process such as differential scanning calorimetry (DSC), differential thermal analysis (DTA), etc. Generally, polymer exhibits melting behaviors over a broad range of temperatures in reflection of the presence of various components having not a single molecular weight, different crystallization degrees, etc. The melting point according to the present invention is defined to be a temperature corresponding to the endothermic peak according to the DSC analysis.

### Thermoplastic Polymer Having a Melting Point of 200° C. or Lower.

Thermoplastic polymer to be used according to the present invention may not be particularly restricted as far as it has a melting point of 200° C. or lower, particularly within the range of 100-180° C., but its example may include polyolefin and low melting fluorine polymer. Examples of the polyolefin may include polyethylene, polypropylene, polybutene, polymethylpentene, copolymers thereof, etc. Examples of the low melting fluorine polymer may include polyvinylidene fluoride, copolymer thereof, etc. Particularly preferable among these are polyethylene and polypropylene. These polymers may include, besides a linear structure, branched chains, cross-linked portions, and other structures, too.

In the separator according to the present invention, since such thermoplastic polymer becomes molten, when heated to the melting point, to acquire increased flowing ability, the polymer can penetrate into gaps formed between its surrounding thin sheet materials of an organic compound not having a stable melting point and can efficiently fill the gaps. Accordingly, a separator according to the present invention can exert an excellent shutting down function.

### Organic Compound Substantially Having no Stable Melting Point

The organic compound substantially having no stable melting point to be used according to the present invention may include the following, among others:
1) The compound subjected to an advancing cross-linking reaction when the temperature is increased by heating so that the melting point is substantially increased to above the decomposition temperature of the compound.
2) The compound having a melting point close to its decomposition temperature so that its thermal decomposition can occur in parallel to its fusion.
3) The compound having no fusion property and thus having no melting point.

According to the present invention, among such organic compounds having said properties, those substantially having no stable melting point at a temperature of 200° C. or lower are particularly preferable. There is no particular restriction on the organic compound which can be used according to the present invention, and examples thereof may include aramid, polyimide, polyamideimide, polyacrylonitrile, polyarylate (totally aromatic polyester), cellulose, polyazomethine, polyacetylene, polypyrrole, etc. Particularly preferable among these is aramid.

### Thin Sheet Material Comprising an Organic Compound Substantially Having no Stable Melting Point

A thin sheet material to be used according to the present invention is not particularly restricted as far as it contains the above described organic compound as a major component and has a sufficient ion penetration required as the separator. An example thereof may include the aramid thin sheet material disclosed in Laid-Open Japanese Patent Application 2003-064595 A.

Porous Sheet Formed from the Thermoplastic Polymer and Incorporating the Thin Sheet Material

A term “incorporating” in an expression “a porous sheet formed from a thermoplastic polymer having a melting point of 200° C. or lower is incorporating a thin sheet material comprising an organic compound substantially having no stable melting point” refers to a situation wherein the thin sheet material is contained in the porous sheet and wherein the surface of the thin sheet material is substantially covered with the thermoplastic polymer.

A process for producing the porous sheet according to the present invention may include, without restriction, a process disclosed, for example, in Published Japanese Patent Application Sho-59-037292 B, wherein a mixture of a) polyolefin such as polyethylene, b) inorganic fine powder such as silica, etc. and c) organic liquids such as mineral oil, dioctyl phthalate, etc. is coated on the thin sheet material for impregnation, and subsequently, the inorganic fine powder and organic liquids are extracted for removal, etc.

The porous sheet according to the present invention, thus formed, is desirably to have a Gurley gas permeability generally of 1,000 seconds or less, particularly within the range of 800-30 seconds. Herein, the Gurley gas permeability represents a time period (expressed in the second unit) as required for 100 cc (0.1 dm³) of air to flow out through a sample, which has been held between clamping plates having a circular orifice area of the 28.6 mm external diameter. It is generally known that good correlation exists between the product of the Gurley gas permeability multiplied with the void (pore) size of the separator and the value of battery resistance. A separator having a Gurley gas permeability in excess of 1,000 seconds is believed to be practically unusable because of a large battery resistance. An appropriate thickness of the porous sheet is within the range generally of 0.01-1 mm, particularly of 0.01-0.1 mm. If the porous sheet is thinner than the lower limit of this range, it may not be able to withstand a tension applied thereon during the process step of assembling batteries. On the other hand, if the porous sheet is thicker than the upper limit of this range, the battery size may become inconveniently larger.

### Aramid

Aramid to be favorably used according to the present invention includes linear, high molecular weight and totally aromatic polyamides wherein 60% or more of linkages connecting the benzene or naphthalene rings are amide linkages. Aramids having the benzene ring may be largely classified into meta-aramids and para-aramids based on the substitution position of the amide linkage.

Examples of the meta-aramid may include polymetaphenylene isophthalamide and copolymers thereof, etc. and examples of the para-aramid may include polyparaphenylene terephthalamide and copolymers thereof, poly(paraphenylene)-copoly(3,4-diphenyleneether) terephthalamide, etc., without any restriction to these examples. The process for producing aramid is not particularly restricted, and generally cited examples include a solution polymerization process by the condensation reaction between an aromatic diamine and an aromatic acid dichloride, a 2-step interfacial polymerization process, etc., while aramid can be industrially produced by any of these processes. Incidentally, as far as the aramid property is not spoiled, other components may be copolymerized together with the aramid.

The shape of aramid to be used according to the present invention is not particularly restricted, but the preferable shape includes aramid fibrid, aramid staple fiber and fibrillated aramid as well as mixtures of 2 or 3 of these aramids.

### Aramid Fibrid

Aramid fibrid signifies filmy aramid particles having paper-forming ability, which is also referred to as aramid pulp (refer to Published Japanese Patent Applications Sho-35-011851 B, Sho-37-005752 B, etc.).

It is widely known that aramid fibrid is useful as a paper-forming material after the treatments of breaking and beating, similarly to ordinary wood pulp, and with the view to maintain the quality adequate for paper forming, aramid fibrid can be given the so called treatment of beating. This treatment of beating can be worked with a disk refiner, beater or other processing machine or instrument for paper-forming materials which exerts a mechanical cutting action. In such the operation, morphological changes in the fibrid can be monitored by a freeness test method prescribed by the Japanese Industrial Standard P-8121. The fineness of the aramid fibrid after the beating treatment preferably lies within a range of 10-300 cm³ (Canadian freeness). When the fibrid has a larger freeness above the upper limit of this range, the aramid thin sheet material formed therefrom is liable to have a reduced strength. On the other hand, attempts to achieve a freeness of less than 10 cm³ can reduce the utilization efficiency of mechanical power inputs and often decrease the processed quantity per unit time. Furthermore, because these attempts can cause excessive progresses in the pulverization of the fibrid, it is apt to invite deterioration in the so called binder function. Hence, no substantial merit can be found in such attempts to obtain a smaller freeness less than 10 cm³.

For the utility intended in the present invention, aramid fibrid is preferably to have a weight average fiber length after the beating treatment of 1 mm or less, particularly within the range of 1-0.8mm, as measured with an optical fiber length measuring apparatus. Herein, as the optical fiber length measuring apparatus, a Fiber Quality Analyzer (made by Op Test Equipment Co.), a KAJAANI Measuring Equipment (made by Kajaani Co.) or the like can be used. With such equipment, the fiber length and form of the aramid fibrid passing a certain light path are observed individually and the measured fiber lengths are statistically processed. However, when the weight averaged fiber length of the aramid fibrid to be used is in excess of 1 mm, reduction in the electrolytic solution absorbency, the occurrence of localized failures in the impregnation of the electrolyte, and furthermore, the consequential rise in the internal resistance of electrical/electronic components, etc. are liable to take place.

### Aramid Staple Fiber

Aramid staple fiber is produced by cutting the fiber produced from aramid as a starting material. Examples of such fiber may include those available under the trade names of “Teijin CONEX®” and “TECHNORA®” (both made by Teijin Ltd.), “NOMEX®” and “KEVLAR®” (both made by E.I. du Pont de Nemours & Co.), “TOWARON®” (made by Teijin Twaron Co.), etc. without restriction to these example.

Aramid staple fiber can be made preferably to have a fineness within the range of 0.05-25 dtex, and particularly of 0.05-1 dtex. Herein, the fineness is defined as the fiber weight (in grams) per 1000 m. Fiber having a fineness of less than 0.05 dtex is objectionable because it tends to easily invite agglomeration during the wet process preparation, while fiber having a fineness of 25 dtex or more tends to have an excessively large fiber diameter, and thus, when it is made to have the density of 1.4 g/cm³ for a truly round shape, the fiber having a diameter of 45 or more is liable to cause defects such as a decrease in the aspect ratio, a reduction in the mechanical reinforcing effect, the unfavorable non-uniformity of the aramid thin sheet material, etc. Here, the non-uniformity of the aramid thin sheet material signifies the broadening in void size distribution to cause the non-uniformity in the mobility of ion species.

The length of aramid staple fibers can be selected between 1 mm and less than 50 mm, particularly within the range of 2-6 mm. When the length of the staple fibers is less than 1 mm, the mechanical characteristics of the aramid thin sheet material are deteriorated, and when the length is 50 mm or more, tangling or sticking is apt to take place during the preparation of an aramid thin sheet material by the wet process to induce further defects.

### Fibrillated Aramid

Fibrillated aramid is formed by fibrillating aramid fiber, aramid fibrid, and the like by the exertion of a shearing force, and the fibrillated aramid is preferably to have a freeness within the range of 10-800 cm³ (Canadian freeness). Fibrillated aramid having a freeness greater above this range is liable to provide an insufficient shielding property between electrodes. On the other hand, attempts to obtain a freeness less than 10 cm³ can excessively advance the pulverization of fibrillated aramid and can aptly invite deterioration in the so called binder function. Therefore, no particular merit can be found in such attempts to achieve a freeness of less than 10 cm³.

Fibrillated aramid is preferably to have a specific surface area of 5 g/m² or larger, particularly of 9 g/m² or larger. A specific surface area of less than 5 g/m² is apt to invite the deterioration in the binder function. Furthermore, fibrillated aramid is preferably to have a weight average fiber length of 0.01 mm or larger but less than 7 mm, and particularly within the range of 0.8˜2.3 mm. Fibrillated aramid having a weight average fiber length greater above the upper limit of this range shows poor dispersibility during the paper forming operation, which may cause local defects in the aramid thin sheet paper, such as the formation of stuck filament, etc. On the other hand, attempts to obtain a weight average fiber length of less than 0.01 mm can promote an excessive progress in the pulverization of fibrillated aramid, and are liable to invite reductions in the so called binder function. Specific examples of the fibrillated aramid may include those available under the trade names of “KEVLAR PULP” made by E.I. du Pont de Nemours & Co., “TWARON PULP” made by Teijin Twaron Co., etc. without restriction to these examples.

### Separator

A separator constituted from thus obtained porous sheet is provided with both the thermoplastic-derived function for efficient shutting-down at a temperature of 200° C. or less and the aramid-derived function for the shape stabilization at a higher temperature, and thus, the separator can be favorably used in non-aqueous electrolyte batteries intended for industrial applications, particularly in lithium secondary batteries. When a battery is installed with a separator according to the present invention, the safety of this battery can be remarkably improved. Such a battery can be not only used in the conventional applications of batteries for electrical devices such as portable telephone sets, personal computers, etc., but also can be applied as an energy storage/generation device for larger sized machines such as electric cars.

Since a separator according to the present invention has a constitution comprising thermoplastic polymer capable of exerting an excellent shutting down function due to its heat shrinkage and melting and aramid capable of exhibiting an excellent property in the function of high temperature shape retention, the separator is provided with not only a very excellent shutting down function but also a great force for shape retention, and furthermore, it can be formed as a thin sheet because a thin sheet material is incorporated. Additionally, the separator is also provided with properties required for secondary battery separators, and can be particularly useful as a battery separator. Electrical and electronic components such as lithium secondary batteries, electric double layer capacitors, etc., which are mounted with the separator according to the present invention, can be utilized as electric power sources for electrical devices such as portable telephone sets, computers, etc. as well as electric cars, hybrid cars, etc.

### EXAMPLES

In the following, the present invention shall be more specifically explained in reference to examples:

### Measuring Methods

### (1) Measuring the Basis Weight and Thickness of Sheet

Measurements were made after the procedures of JIS C-2111.

### (2) Gurley Gas Permeability

A Gurley densometer as specified in JIS P-8117 was used to measure a time (in seconds) required for 100 cc (0.01 dm³) of air to pass through the sample sheet (having the area of 642 mm²) held between clamping plates having a circular orifice area of the 28.6 mm external diameter.

### (3) Porosity

Calculated as [(void volume)/(porous sheet volume)]×100(%) wherein (void volume)=(wet weight)−(dry weight).

### Referential Example (Preparation of Starting Materials)

The fibrid of polymetaphenylene isophthalamide was prepared according to a method using a wet precipitation machine comprising a stator/rotor combination as described in Published Japanese Patent Application Sho-52-151624 B. The fibrid was processed in a breaker and a beater to adjust the weight average fiber length to 0.9 mm.

Separately, metaramid fiber (NOMEX®) made by E.I du Pont de Nemours & Co.) was cut to the length of 6 mm to obtain aramid staple fiber.

### Example 1

### Preparation of Thin Sheet Material

Thus prepared aramid fibrid and aramid staple fiber were respectively dispersed in water to form slurries. In the slurries, the fibrid and the aramid staple fiber were blended at the blend ratio as shown in Table 1, and a sheet-shaped object was formed on a TAPPI-type manual sheeting machine (having the cross sectional area of 325 cm²). Next, this object was processed for hot pressing on metallic calendaring rolls at the temperature of 295° C. and the linear pressure of 300 kg/cm to obtain an aramid thin sheet material.

### Preparation of Porous Sheet

Thirteen (13)% by volume of fine silicic acid powder and 61.5% by volume of dioctyl phthalate were blended in a Henschel mixer, and upon the addition of 25.5% by volume of polyethylene having the weight average molecular weight of 600,000 and the Mw/Mn ratio of 15, the mixture was further blended in a Henschel mixer.

The above obtained thin sheet material was impregnated with this mixture by coating, and the impregnated material was subsequently immersed in 1,1-dichloroethane for 5 minutes for the extraction of dioctyl phthalate to be followed by drying. The dried material was then further immersed in a 20% caustic soda solution for 30 minutes at the temperature of 70° C. for the extraction of silicic acid, to be followed by drying. Properties of a porous sheet thus obtained are shown in Table 1.

TABLE 1

| | | |
|---|---|---|
| Properties | Units | Example |

(Starting material composition)

| | | |
|---|---|---|
| aramid fibrid | % by weight | 5 |
| aramid staple | | 49 |
| fiber | | |
| polyethylene | | 46 |
| Staple fiber fineness | Dtex | 0.9 |
| Basis weight | g/m² | 18.5 |
| Thickness | μm | 25 |
| Density | g/m³ | 0.74 |
| Porosity | % | 35.5 |

The porous sheet had the Gurley gas permeability at room temperature of 400 seconds/100 mL, and the pores were closed upon heating at 200° C. for 5 minutes to give the Gurley gas permeability at room temperature of ∞ seconds/100 mL. Thus, the porous sheet was confirmed to have the shutting-down property. The deformation or shrinkage of the sheet itself was not observed in this test.

### Comparative Example 1

Porous polypropylene film (Celguard TM2400 made by Celgard Corp.) had the air permeation time at room temperature of 350 seconds/100 mL, and the pores were closed upon heating at 200° C. for 5 minutes to give the Gurley gas permeability at room temperature of ∞ seconds/100 mL. Thus, the shutting-down property could be obtained, but the film itself was significantly deformed and shrunken.

1. A separator which comprises a constitution wherein a porous sheet formed of a thermoplastic polymer having a melting point of 200° C. or lower is incorporating a thin sheet material comprising an organic compound substantially having no stable melting point.

2. A separator as set forth in claim 1, wherein the organic compound substantially has no stable melting point at a temperature of 200° C. or lower.

3. A separator as set forth in claim 1, wherein the organic compound is selected from the group consisting of aramid, polyimide, polyamide imide, polyacrylonitrile, polyarylate (totally aromatic polyester), celluloses, polyazomethine, polyacetylene and polypyrrole.

4. A separator as set forth in claim 1, wherein the organic compound is aramid.

5. A separator as set forth in claim 4, wherein the aramid is in at least one of shapes selected from the group consisting of aramid fibrid, aramid staple fiber and fibrillated aramid.

6. A separator as set forth in claim 1, wherein the thermoplastic polymer has a melting point within the range of 100-180° C.

7. A separator as set forth in claim 1, wherein the thermoplastic polymer is polyolefin.

8. A separator as set forth in claim 1, wherein the polyolefin is polyethylene or polypropylene.

9. A separator as set forth in claim 1, wherein the porous sheet has a Gurley gas permeability of 1,000 seconds or less.

10. A separator as set forth in claim 1, wherein the porous sheet has a thickness within the range of 0.01-1 mm.

11. Electrical/electronic components using the separator as set forth in claim 1 as a separator between conductive members.
